(19) United States
(12) Patent Application Publication
(10) Pub. No.: US 2012/0026971 A1
(43) Pub. Date: Feb. 2, 2012

(54) WIRELESS NETWORK SYSTEM, A MOBILE DEVICE, AN INFORMATION SERVER AND A METHOD OF PROVIDING INFORMATION IN A WIRELESS NETWORK SYSTEM

(75) Inventors: Ankur KHANDELIA, Staines (GB); Rajiv Azhapilli, Staines (GB)

(73) Assignee: Samsung Electronics Co., Ltd., Suwon-si (KR)

(21) Appl. No.: 13/194,124

(22) Filed: Jul. 29, 2011

(30) Foreign Application Priority Data
Jul. 30, 2010 (GB) 1012838.7
Jul. 12, 2011 (KR) 10-2011-0069150

(51) Int. Cl. H04W 36/14

(52) U.S. Cl. 370/331

(57) ABSTRACT

A wireless network system including a plurality of wireless networks is provided. The wireless network system includes a plurality of mobile devices coupled to the plurality of wireless networks, the plurality of mobile devices including at least a first mobile device and a second mobile device; and an information server coupled to each of the plurality of wireless networks, wherein the information server provides handover messages to the plurality of mobile devices to assist the mobile devices in performing a handover from one of the wireless networks to another one of the wireless networks, wherein the first mobile device negotiates information sharing rules with the information server, and wherein the first mobile device provides, to the second mobile device, shared information according to the information sharing rules.

### PRIORITY

This application claims priority under 35 U.S.C. §119(a) to a Application filed in the Korean Intellectual Property Office on Jul. 12, 2011 and assigned Serial No. 10-2011-0069150 and an Application filed in the Great Britain Intellectual Property Office on Jul. 30, 2010 and assigned Serial No. GB 1012838.7, the entire contents of which are incorporated herein by reference.

### 1. TECHNICAL FIELD

The present invention relates generally to a wireless network system, and in particular, to a wireless network system including a mobile device, an information server and a method of providing information in the wireless network system.

### 2. DESCRIPTION OF RELATED ART

Several different wireless networks may coexist in one particular location. For example several networks may be offered by different providers and different wireless network technologies may overlap. In such a heterogeneous wireless network system, mobile devices may have a choice of available access points a particular location, and such options may frequently change as the mobile devices move around to different locations with different network systems.

Protocols such as Institute of Electronics and Electrical Engineers (IEEE) 802.21, as well as other protocols, have been developed in order to provide handover services that assist HandOver (HO) from one access point to another access point, and from one type of network to another type of network, while maintaining services over the wireless networks to the mobile devices. These protocols provide additional services such as predictive handovers, wherein a handover to another access point is initiated before a signal from a current access point is lost, in order to minimize downtime between access points. However, some mobile devices (e.g. non-MIH devices) are unable to participate in these additional services for media independent handovers. For example, WO2006/052,805 describes a Media Independent Handover (MIH) method featuring a simplified beacon for MIH services.

Many mobile devices are able to generate location information that corresponds to a geographical location of the mobile device. The location information allows the mobile device to obtain location based services that are relevant to that specific geographical location. For example, location information may be provided in order to access additional services for media independent handovers, such as the predictive handovers based on the current geographical location of the mobile device. However, obtaining the location information tends to increase the power consumption of the mobile device and shortens battery life. The wireless network also carries additional network traffic in order to provide the location information and support the location based services of the mobile device. Meanwhile, devices that are not equipped to generate the location information (e.g., devices without a Global Positioning System (GPS) locator) are unable to take advantage of these location based services.

Accordingly, there is a desire to achieve a wireless network system wherein information is provided efficiently. For example, there is a desire to achieve a wireless network system wherein network traffic is reduced, to conserve battery power of the mobile devices, and to achieve a method of providing information in a wireless network system wherein the information is efficiently provided.

### SUMMARY OF THE INVENTION

Accordingly, the present invention has been made to solve the above-mentioned problems occurring in the prior art, and provides a wireless network system including a mobile device and an information server, and a method for providing information in the wireless network system.

According to one aspect of the present invention, a wireless network system including a plurality of wireless networks. The wireless network system includes a plurality of mobile devices coupled to the plurality of wireless networks, the plurality of mobile devices including at least a first mobile device and a second mobile device; and an information server coupled to each of the plurality of wireless networks, wherein the information server provides handover messages to the plurality of mobile devices to assist the mobile devices in performing a handover from one of the wireless networks to another one of the wireless networks, wherein the first mobile device negotiates information sharing rules with the information server, and wherein the first mobile device provides, to the second mobile device, shared information according to the information sharing rules.

According to another aspect of the present invention, a method of providing information in a wireless network system having a plurality of wireless networks is provided. The method includes sending, by an information server, handover messages to a first mobile device in the wireless network system; performing, by the first mobile device, a handover from one of the plurality of wireless networks to another one of the wireless networks using the handover messages; negotiating, by the first mobile device, information sharing rules with the information server; and providing, by the first mobile device, shared information to a second mobile device according to the information sharing rules.

According to another aspect of the present invention, a non-transitory computer readable medium having recorded thereon instructions which, when executed, cause a computer to perform a method that includes sending, from an information server, handover messages to a first mobile device in a wireless network system having a plurality of wireless networks; performing a handover of the first mobile device from one of the wireless networks to another of the wireless networks using the handover messages; negotiating information sharing rules between the information server and the first mobile device; and sending shared information from the first mobile device to a second mobile device according to the information sharing rules.

### BRIEF DESCRIPTION OF THE DRAWINGS

The above and other aspects, features and advantages of the present invention will be more apparent from the following detailed description taken in conjunction with the accompanying drawings, in which:

FIG. 1 is a schematic diagram illustrating a wireless network system according to an embodiment of the present invention;

FIG. 2 is a detailed schematic diagram illustrating the wireless network system according to an embodiment of the present invention;

FIG. 3 is a schematic diagram illustrating a wireless network system according to an embodiment of the present invention;

FIG. 4 is a flowchart illustrating a method of providing information in a wireless network system according to an embodiment of the present invention;

FIG. 5 is a flowchart illustrating another method of providing information in a wireless network system according to an embodiment of the present invention;

FIG. 6 is a schematic diagram of a wireless network system according to an embodiment of the present invention;

FIG. 7 is a schematic diagram illustrating an example wireless network system according to an embodiment of the present invention;

FIG. 8 is a schematic diagram illustrating a wireless network system according to an embodiment of the present invention; and

FIG. 9 is a schematic diagram illustrating a wireless network system according to an embodiment of the present invention.

### DETAILED DESCRIPTION OF THE EMBODIMENTS OF THE PRESENT INVENTION

Hereinafter, embodiments of the present invention are described with reference to the accompanying drawings. In the following description, the same elements will be designated by the same reference numerals although they are shown in different drawings. Further, a detailed description of known functions and configurations incorporated herein will be omitted for the sake of clarity and conciseness.

Embodiments of the present invention are described herein with reference to independent handover in a heterogeneous network system. The following examples relate in particular to media independent handover using the IEEE802.21 protocol as described, for example, at www.ieee802.org. However, the principles and teachings herein are also applicable to other convergence technologies for heterogeneous networks, as will be appreciated from the following description and discussion.

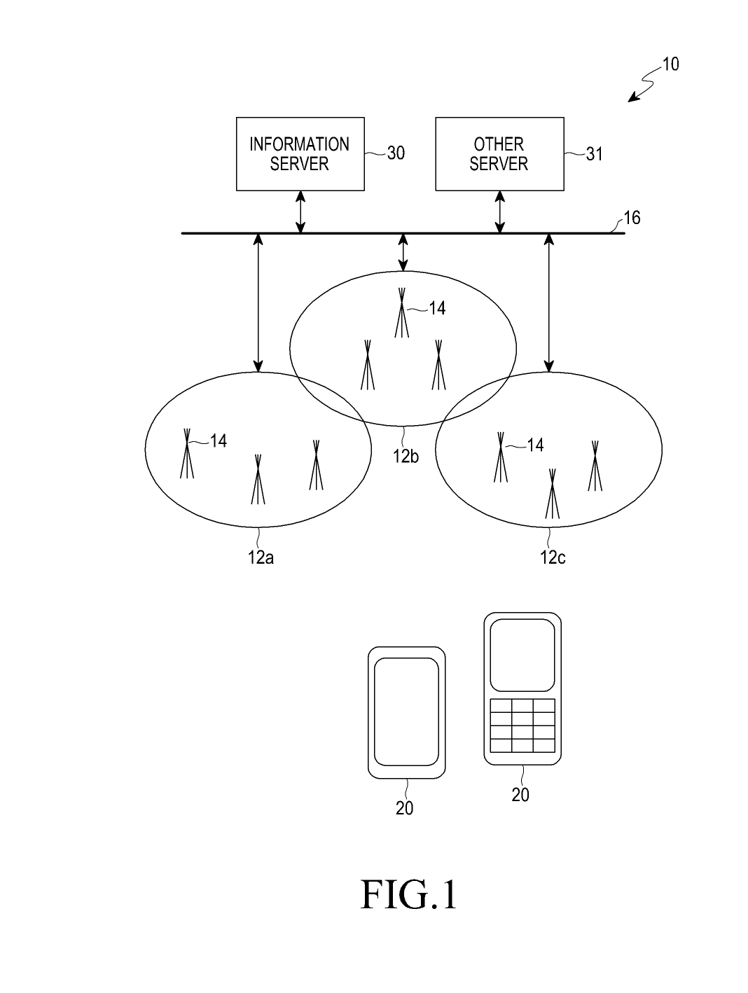

FIG. 1 is a schematic diagram of an example heterogeneous wireless network system.

Referring to FIG. 1, a wireless network system 10 includes one or more wireless networks 12a, 12b, 12c each with an associated set of the access points 14, so that many individual mobile devices 20 can access the wireless networks from diverse locations. The network 10 will typically span entire cities, regions or countries. The many access points 14 often have overlapping coverage at specific locations (such as in an airport or on a particular street), where the mobile devices 20 may choose between the available access points 14. This set of available access points 14 changes frequently as the mobile devices 20 move around the region covered by the wireless network system 10.

According to embodiments of the present invention, the wireless networks 12a-12c use a plurality of wireless network technologies. The wireless networks 12a-12c may include cellular telephony networks using technologies such as Global System for Mobile communication (GSM), General Packet Radio Service (GPRS), Enhanced Data Rates for GSM Evolution (EDGE), or Code Division Multiple Access (CDMA), or wireless local area networks such as IEEE802.11 (Wireless Fidelity (WiFi)) or IEEE802.16 (Worldwide Interoperability for Microwave Access (WiMAX)), amongst others, as will be familiar to those skilled in the art. More recently, protocols and standards such as IEEE802.21 have been developed to aid media independent handovers from one access point 14 to another and from one network 12 to another, while maintaining services to the mobile devices 20. Most wireless networks 12 provide homogeneous (horizontal) handovers within the same network. However, IEEE802.21 is an example of convergence for MIH, which also supports vertical handovers in a heterogeneous network system. Other examples include Unlicensed Mobile Access/Generic Access Network (UMA/GAN) as part of European Telecommunications Standards Institute 3rd Generation Partnership Project (ETSI 3GPP), and Access Network Discovery And Selection Function (ANDSF).

The access points 14 include any suitable equipment or station used to provide a network connection or point of access to communicate wirelessly with the mobile devices 20. For example, the access points include base stations or base transceivers for routing network traffic to the mobile devices 20.

The mobile devices 20 (also referred to as “Mobile Nodes” (MNs)) are capable of connecting to one or more of the wireless networks 12. Typically, the mobile devices 20 are smartphones, Personal Digital Assistants (PDAs), notebooks, webbooks or other suitable portable communication devices. These mobile devices 20 suitably have multi-radio capabilities and are capable of connecting to several different types of the wireless networks 12.

One or more wired backbone networks 16 may be provided coupled to the wireless networks 12. These backbone networks allow services to be provided across each of the wireless networks 16. The backbone may be based on Internet Protocol (IP), or other protocols.

As shown in FIG. 1, a plurality of servers are coupled to the wireless networks 12. In this simplified example, an information server 30 and another network server 31 are provided. These servers 30, 31 provide services to the mobile devices 20 over the networks 12. For example, the information server 30 may be an information server for handover services, such as a Media Independent Information Server (MIIS) for MIH. The information server 30 may be compatible with a protocol for media independent handover, such as 802.21, UMA/GAN, or ANDSF.

The information server 30 suitably includes a list of available networks (802.11/16/22, GSM, UMTS, etc), link layer information, and neighbor maps that plot the geographical location or coverage area of particular access points 14. The information server 30 may also provide higher layer services (e.g. internet service provider ISP, multimedia server MMS, etc). In particular, the information server 30 provides an information service that assists network discovery and selection, which leads to more effective handover decisions by the mobile devices 20.

In one example according to an embodiment of the present invention, the mobile devices 20 provide cell information based on their current access point 14. The information server 30 is suitably arranged to respond with events or notifications that assist handovers from one access point 14 to another. The handover may be initiated by the mobile device 20 and is assisted by the information server 30 based on information generated by the mobile device (such as the cell information). In another example, the handover is initiated by the current serving network 12a and is assisted by information server 30 based on the provided information. Suitably, the information server 30 provides handover data that allows the mobile device 20 or the network 12a, as appropriate, to decide whether a handover is required and to select the target access point 14 that will be used next. The handover can then be performed quickly and efficiently with minimal loss of service for the applications or services that are being executed on the mobile device 20.

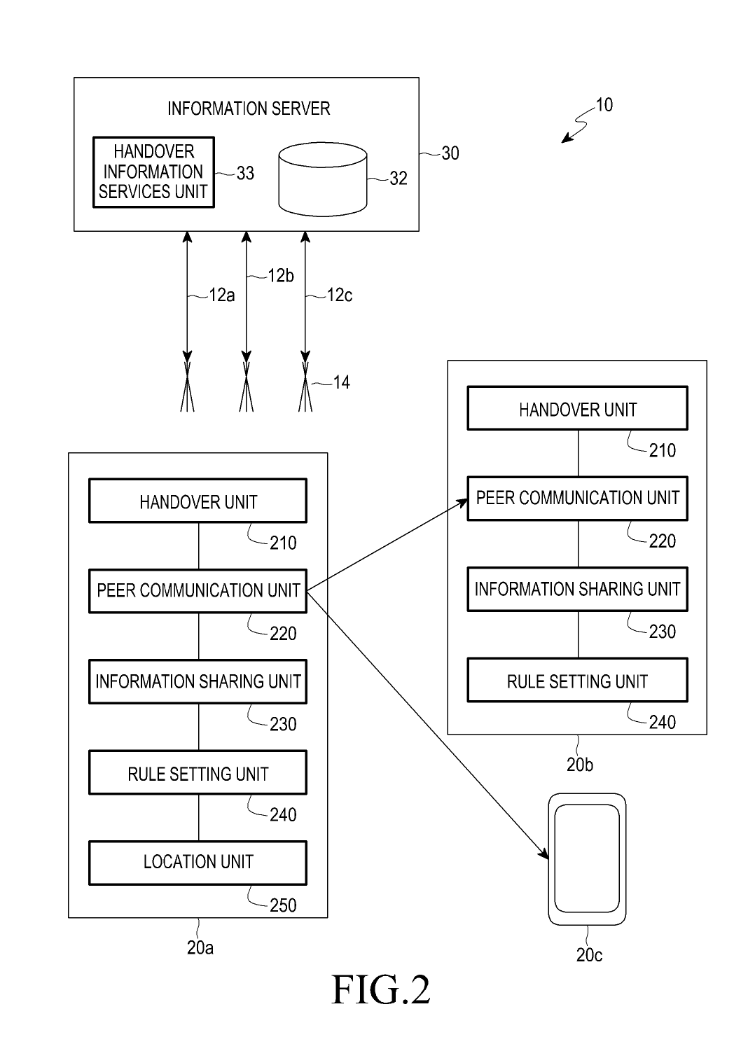

FIG. 2 is a schematic diagram illustrating a wireless network system 10 in more detail according to an embodiment of the present invention.

Referring to FIG. 2, the wireless network system 10 includes the information server 30, a first mobile device 20a, a second mobile device 20b, and a third mobile device 20c. The information server 30 includes an information sharing rule database 32 and a handover information services unit 33. The first mobile device 20a and the second mobile device 20b each include their own handover unit 210, peer communication unit 220, information sharing unit 230, and rule setting unit 240.

As discussed above, the handover unit 210 communicates with the networks 12 to perform efficient handovers between the access points 14. As one example, the handover unit 210 is arranged to communicate with the information server 30 according to a handover protocol, such as 802.21, etc., as discussed above.

Handover messages may be exchanged between the networks 12 and the mobile device 20 performing the handover. These messages may include event notifications such as “wireless link going down”, commands such as “Initiate Handover” which may also include a list of alternative access points, or an information service such as performance information (e.g., delay from the wireless layer), network information (e.g. a request for the current Internet Service Provider (ISP) Name), or the availability of location-based services.

In a typical handover procedure, the handover unit 210 in the mobile device 20a receives a “link going down” indication relating to a cellular network 12a that the mobile device is currently using (also termed the “serving network”). The handover unit 210 may determine from policy configuration parameters whether the link has become less than a threshold value for a specified period of time. If the link has become less than the threshold value, the handover unit 210 triggers a “Get Information Request” to the information server 30. The serving network 12a then responds with information about neighboring networks 12b, 12c, which includes a list of the networks, their cost of connection, security parameters, quality of service, operator identity, etc. Suitably, this neighbor information is based on cell identity information provided by the mobile device 20a relevant to the current access point 14. The handover unit 210 then evaluates the list of networks based on its policy configuration parameters and decides one or more candidate networks. The handover unit 210 then sends the selected candidate networks 12b, 12c a query request such as a “candidate query request”. This query request is typically passed to a mobility management server (not shown) in that candidate network 12b, 12c.

After a candidate query response from the candidate network, the handover unit 210 sends a “commit request” to the mobility management server in the respective candidate network. After a commit response, the handover unit 210 starts preparing a selected link adaptor, by opening up the link adapter for the new network 12b, 12c or new access point 14. When the adaptor opening is successful, the handover unit 210 sends a “complete request” to the new candidate network 12b or 12c. After the “complete request” is transmitted, the handover unit 210 informs relevant applications executing on the mobile device 20a (e.g., Voice Call Continuity (VCC), Session Initiation Protocol (SIP), Mobile Internet Protocol (MIP), etc) to handover to the selected candidate network 12b or 12c.

A change from one of the access points 14 to another access point 14 in the same network 12a, 12b, 12c, is usually supported by the relevant wireless technology of that network. For example, a Voice over Internet Protocol (VoIP) call from a WiFi handset to a WiFi access point can be handed over to another WiFi access point within the same network, e.g. within a corporate network. However, if the handover is from a WiFi access point in a corporate network to a public WiFi hotspot, then a vertical handover is required, because the two access points cannot communicate with each other at a link layer, and are in general on different IP subnets.

As shown in FIG. 2, the peer communication unit 220 is arranged to communicate directly with other mobile devices, such as with the second mobile device 20b and/or the third mobile device 20c, which are in the locality of the first mobile device 20a. As one example, the peer communication unit 220 performs personal area networking, such as using Bluetooth. As another example, the peer communication unit 220 may use Near Field Communication (NFC). Thus, the peer communication unit 220 is able to communicate directly with the other nearby devices 20b, 20c.

The information sharing unit 230 shares information from the first mobile device 20a with the other devices 20b, 20c using the peer communication unit 220. More specifically, the information sharing unit 230 suitably broadcasts the information to the nearby devices 20b, 20c, according to information sharing rules.

The rule setting unit 240 negotiates the information sharing rules with the information server 30 and sets the sharing rules in the mobile device 20a. The information sharing unit 230 then applies these sharing rules to determine the information sharing with the other nearby devices 20b, 20c.

As shown in FIG. 2, the information sharing rule database 32 suitably holds the information sharing rules relevant to each of the capable mobile devices 20a, 20b. In the present example, these rules are negotiated by the handover information services unit 33 during a “capability exchange” message between the relevant mobile device 20a, 20b and the information server 30. The rules can be updated, such as by using a “get_information_indication” service. The information sharing rules may be negotiated for the first mobile device 20a according to “Information sharing allowed when battery is above 50%”. Thus, the information sharing rules are based on a device status of the mobile devices. This device status relates to a hardware component of the mobile devices, such as the battery. As an alternative, the sharing rules may be based on a location of the mobile devices (e.g., by sharing information when “away from home”, but not when “at home”, or vice versa).

As one example, the first mobile device 20a further includes a location unit 250 such as a GPS location unit that calculates location information (e.g., location coordinates) based on satellite signals. Positioning devices other than a GPS device may also be used in accordance with embodiments of the present invention. The mobile device 20 transmits the calculated location information to the information server 30 using the handover unit 210. The location information may further include direction information and/or speed information, which may be obtained from speed sensors and/or direction sensors within the mobile device 20a, or by plotting successive locations over time.

In the present example, the second mobile device 20b also communicates with the information server 30. The handover unit 210 within the second mobile device 20b informs the information server 30 of information sharing request information relevant to the second mobile device 20b, such as location information, device status information and device requirements.

The second mobile device 20b requests the information server 30 to provide assistance from other devices for obtaining GPS-type location information. Therefore, the second mobile device 20b seeks to receive a function or feature that can be fulfilled by sharing information.

The second mobile device 20b may informs the information server 30 of its location, thereby enabling the information server 30 to identify other nearby devices that are suitable for sharing information.

The second mobile device 20b may scan for other nearby mobile devices to obtain identity information of the nearby devices. For example, the second mobile device 20b may scan for nearby devices using the peer communication unit 220 and obtains the peer communication identity (e.g. Bluetooth identity) of, in this case, the first mobile device 20a. The second mobile device 20b then transfers the gathered identity to the information server 30 to identify the first mobile device 20a as a candidate for providing information.

The information server 30 then refers to the rule setting database 32 and issues a command to one or more of the mobile devices near to the second mobile device 20b based on the negotiated rules. In one example, the information server 30 may contact the identified first mobile device 20a to perform the rules negotiation or update the negotiated rules, triggered by this request for information sharing made by the proximal second device 20b.

The first mobile device may contain an identifier with a tag that identifies the first mobile device 20a to the information server 30 (e.g. a Bluetooth identifier). Further, this tag suitably indicates whether the device is capable of performing the information sharing. For example, the tag may contain “MIH” to identify that this device is MIH compatible. When the second mobile device 20b has a functionality or information requirement, the second mobile device 20b scans the nearby devices to identify compatible devices. After the first mobile device 20a is identified as a potentially compatible device, the information sharing rules are negotiated and then implemented with the information server 30.

The information server 30 issues an information sharing command, which is received via the handover unit 210 of the first mobile device 20a and is passed to the information sharing unit 230. In response, the peer communication unit 220 transmits the location information generated by the location information unit 210 over the peer communication network, such as Network File System (NFS) or Bluetooth, to be received by the nearby second mobile device 20b.

As noted above, the first mobile device 20a is arranged to negotiate the information sharing rules with the information server 30 during a capability exchange message between the first mobile device 20a and the information server 30. During the capability exchange message, the first mobile device 20a may include shared information embedded in one of the messages. For example, within the message ‘get info request (location)’, the first mobile device 20a may include its location. This message is normally used for identifying nearby access points 14 for handover procedures.

The information server 30 extracts the shared information from the first mobile device 20a during the capability exchange message, and then transmits the shared information to the second mobile device 20b.

After the information server 30 receives the capability exchange message, such as ‘get info request (location)’, the information sever 30 may extract the location information of the first mobile device 20a and transmit the extracted location information to the second mobile device 20b, if the information sharing rules have already been negotiated.

Table 1 is an example of the message structure used to establish the information sharing rules with the mobile devices 20. In the example of Table 1, the information sharing rules are exchanged using structured information such as XML.

TABLE 1
MIH Header

Source Identifier = sending MIHF ID (Source MIHF ID TLV)
Destination Identifier = receiving MIHF ID (Destination MIHF ID TLV)
InfoResponseBinaryDataList (optional)
InfoResponseRDFDataList (optional)

Table 2 is an example of an information response provided from the information server 30 to the mobile device 20. In the example of Table 2, the information server 30 sets an information sharing rule in which the first mobile device 20a is expected to share GPS location information with the mobile device having the client identity “Client MIHF_ID 1” for the next 10 minutes, provided that the battery level of the first mobile device 20a remains above “70%”.

TABLE 2
Sample Info response RDF Data List from information server:

0:

<?xml version=“1.0” encoding=“utf-8”?>
<sparql xmlns=“http://www.w3.org/2005/sparql-results#”>

<head>

<variable name=“rule startup”/>

</head>
<results>

<result>

<binding name=“rule start up”><literal>config rule</literal></binding>
<binding name=“GPS sharing”><literal>ON</literal></binding>
<binding name=“Client ID”><literal>Client MIHF_ID 1</literal></binding>
<binding name=“Accept Clients”><literal>ON</literal></binding>
<binding name=“Time interval”><literal>10 min</literal></binding>
<binding name=“Battery Level”><literal>70 %</literal></binding>

</result>

</results>

</sparql>

The mobile devices 20a, 20b transmit a “get_information_client” request message and a corresponding “get_information_client” response message for this peer-to-peer communication between the mobile devices 20a, 20b, thereby using the close community communication interface (such as Bluetooth interface) to share information directly between the devices.

The information sharing is performed by the first mobile device 20a, which has a relatively high battery power in order to assist the second mobile device 20b, which has a relatively low battery power. The second mobile device 20b does not itself have a GPS function (i.e., the second mobile device 20b is a non-GPS device), but the second mobile device 20b is now able to take advantage of the GPS location provided by the first mobile device 20a in an efficient manner. In another example, the second mobile device 20b may be provided with a corresponding GPS unit 250, but the GPS unit 250 of the second mobile device 20b can be temporarily switched off at to conserve power. Further, since the first and second devices 20a and 20b share information directly by the peer communication, overall traffic on the wireless networks 12 can be reduced.

Typically, the location based services are provided at a coarse level based on a cellular location, such as a cell identity of the current access point 14. However, the location based services are also provided on a fine level when the more accurate and detailed coordinate-based location information is available, such as specific coordinates derived from the GPS location unit 250. Therefore, using the coordinate based location information, such as GPS location information shared by the first mobile device 20a, allows for better service to be obtained by the second mobile device 20b when it is located near the first mobile device 20a.

The sharing roles as information provider and information receiver may be changed or redistributed periodically. For example, after a predetermined period, the second mobile device 20b reactivates its GPS locator unit 250 and shares the GPS location information with the first mobile device 20a, while the GPS unit 250 of the first mobile device 20a is turned off to conserve power.

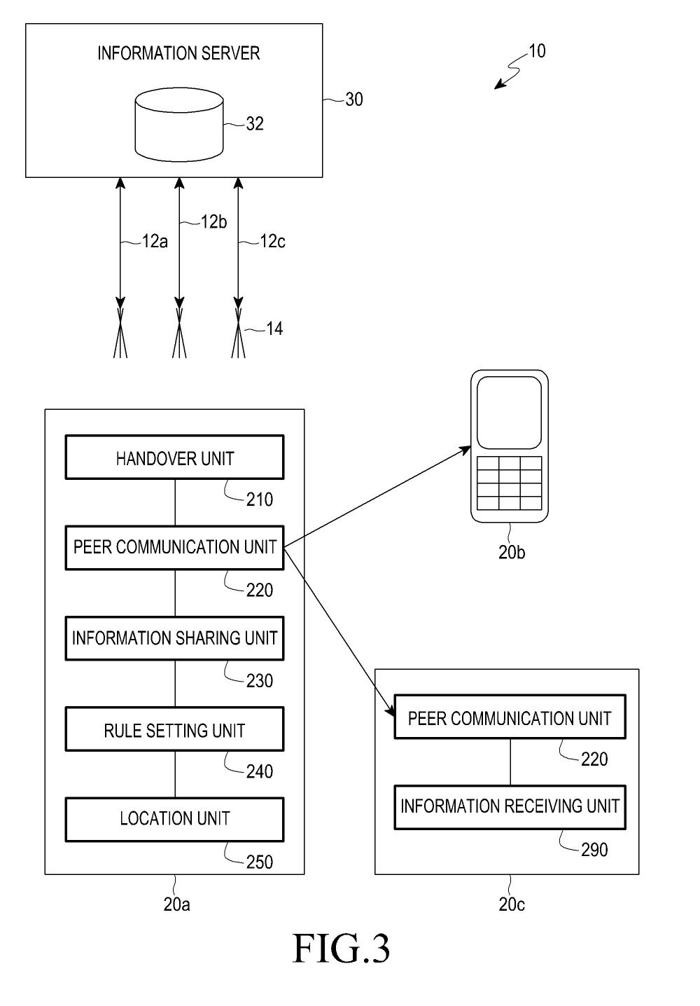

FIG. 3 illustrates an embodiment including the same mobile devices 20a, 20b, 20c, etc., as discussed above. Referring to FIG. 3, the third mobile device 20c includes the peer communication unit 220 such as Bluetooth or NFS, and therefore, is also capable of receiving the information being shared by the first mobile device 20a. The third mobile device 20c also includes an information receiving unit 290 that processes and delivers the received shared information to be used by applications within the third mobile device 20b. The third mobile device 20a does not include the handover unit 210, and therefore, is not capable of communicating directly with the information server 30. However, the third mobile device 20a is still able to benefit from the information sharing that has been triggered using the information server 30.

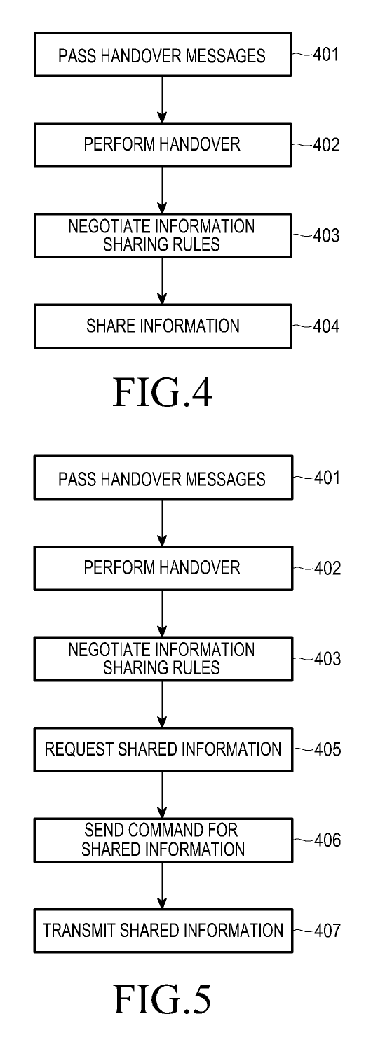

FIG. 4 is a flowchart illustrating an example method of providing information in a wireless network system according to an embodiment of the present invention. The method of FIG. 4 is performed by the information server 30 and the mobile devices 20, etc, as discussed herein.

Referring to FIG. 4, in step 401, the handover messages are exchanged between the information server 30 and the plurality of mobile devices 20a, 20b, 20c. In step 402, at least one of the mobile devices 20a from one of the wireless networks 12a performs a handover to another of the wireless networks 12b using the handover messages. In one example, the at least one of the mobile devices 20 performs the handover from one of the access points 14 within the first network 12a to one of the access points 14 on the second network 12b using access point information provided by the information server 30 in the handover messages. In step 403, the first mobile device 20a negotiates the information sharing rules with the information server 30. For example, the first mobile device 20a may allow sharing of GPS location information when the battery level of the first mobile device 20a is above 50%.

In step 404, information from the first mobile device 20a is directly shared with the second mobile device 20b via peer communication (such as Bluetooth) according to the information sharing rules. Here, the second mobile device 20b is located close to the first mobile device 20a. The information sharing continues for a predetermined period. Optionally, the information sharing roles may be reversed, after the predetermined period, with the second mobile device 20b now sharing GPS location information with the first mobile device 20a.

FIG. 5 is a flowchart illustrating another method of providing information in a wireless network system according to an embodiment of the present invention. Steps 401, 402 and 403 are the same as described herein with respect to FIG. 4. In step 405, a request for information sharing is sent from the second mobile device 20b to the information server 30. This request is conveniently based on a hardware component of the second mobile device, such as whether a GPS unit is present in the mobile device 20b, whether the GPS unit is turned off, or whether a power level of a battery is below a preset threshold.

In step 406, a command for information sharing is issued to the first mobile device 20a according to the information sharing rules. More specifically, the information server 30 checks the information sharing rule database 32 and determines that the first mobile device 20a is willing to share GPS information and is located near to the second mobile device 20b. The information server 30 then issues the command to the first mobile device 20a accordingly. For example, the command requests information sharing of GPS location information for a period of 10 minutes and provides the Bluetooth identity of the second mobile device 20b. In a manner similar to step 404 above, in step 407, the shared information is transmitted, via the peer communication, from the first mobile device 20a to the second mobile device 20b in response to the command and according to the information sharing rules.

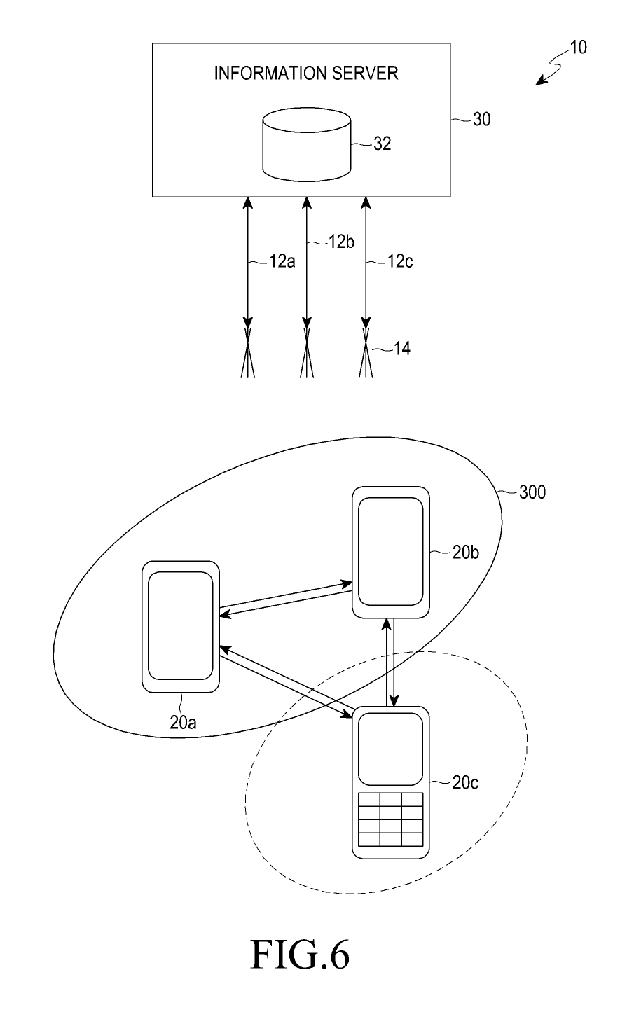

FIG. 6 illustrates an example a wireless network system 10 including the same mobile devices 20a, 20b & 20c, etc., as discussed above, according to an embodiment of the present invention.

Referring to FIG. 6, the information server 30 aggregates a plurality of the mobile devices 20a, 20b & 20c into a sharing group 300 based on the location information provided by the mobile devices 20a, 20b & 20c. In the present example, the information server 30 determines that the first mobile device 20a and the second mobile device 20b are in the same location and are suitable for sharing information using the peer communication. As a result, the information server 30 allocates the first and second mobile devices 20a, 20b as a sharing group, and triggers the information sharing between the devices as described above. In the present example, the first mobile device 20a shares GPS location information, and the GPS unit 250 of the second mobile device 20b is temporarily switched off to conserve power.

The information server 30 may also form the sharing group based on the speed and direction information received from the mobile devices 20a, 20b & 20c. For example, if the mobile devices 20a, 20b & 20c are all on board a train, the mobile devices 20a, 20b & 20c will travel along the same path at the same speed. In this case, the information server 30 triggers the information sharing group based on this coordinated location information. The information is then shared by peer communication among the mobile devices 20a, 20b & 20c in the sharing group 300 according to the previously arranged sharing rules. Further, the third mobile device 20c, which is also travelling on the same train, can also now receive the shared information from the first mobile device 20a over the peer communication.

According to an embodiment of the present invention, the information server 30 may send predictive events or notifications, such as to assist a predictive handover from one access point 14 to another. Conveniently, these predictive events or notifications take advantage of location information provided by the mobile devices 20a, 20b & 20c. Hence, the GPS coordinate-based location information allows the location based service to be provided at a detailed level. As described above, the information sharing of GPS location information by the first mobile device 20a allows the second mobile device 20b to take advantage of this location based service. In this example, the mobile devices 20a, 20b & 20c in the sharing group 300 share access point information relating to the access points 14 of the wireless networks 12a-12c. More specifically, the information server 30 provides predictive notifications concerning a sequence of the access points 14 that will be available to the sharing group based on the provided location information and path information (e.g., speed & direction).

For example, the mobile devices 20a, 20b & 20c of the sharing group 300 may be determined to be on a train and will encounter an access point A, then a tunnel with no coverage, followed by an access point B. This access point information is shared from the first mobile device 20a to the second mobile device 20b, etc. Sharing this access point information between the mobile devices 20a, 20b & 20c reduces overall network traffic compared with the information server 30 providing the access point information directly to each of the devices separately. Further, the shared access point information is also provided to other devices such as the third mobile device 20c. In this example, the devices 20a, 20b & 20c in the sharing group 300 are all now able to predict the loss of coverage in the tunnel and prepare their respective applications accordingly, such as putting an application on hold while there is no network coverage. Further, all of the devices 20a, 20b & 20c are provided with the access point information to perform a predictive handover to the access point B ready for when the train emerges from the tunnel. In this example, each of the devices 20a, 20b & 20c in the sharing group 300 experience a better service, the service is extended to a wider group of devices, and overall network traffic is reduced.

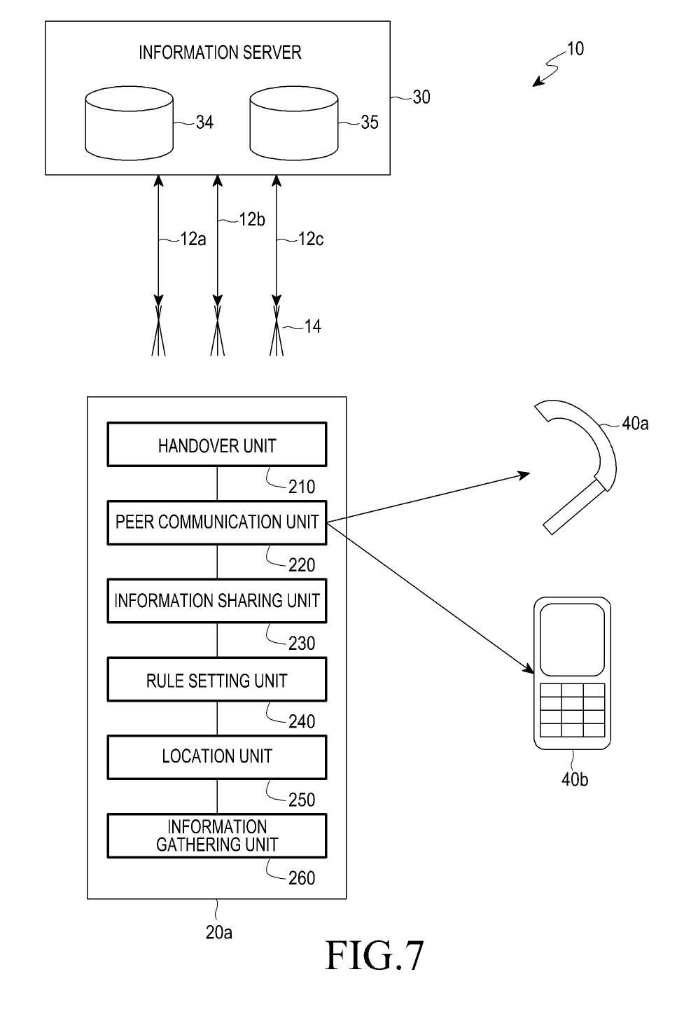

FIG. 7 illustrates another example of a wireless network system including the same mobile devices 20a, 20b, etc.

Referring to FIG. 7, users frequently misplace important devices such as their mobile phone, Bluetooth headset, etc. In the example of FIG. 7, the mobile device 20a includes an information gathering unit 260 that gathers and selectively stores peer information about a plurality of peer communication devices 40a, 40b. This information is gathered by the peer communication unit 220 according to the previously determined information gathering rules. These information gathering rules are suitably negotiated by the rule setting unit 240. The information gathering rules may be stored centrally in an information gathering rules database 34 at a remote server such as the information server 30.

An information gathering rule may be set whereby the information gathering unit 260 is arranged to gather and store a peer communication identity of each peer device 40a, 40b that is encountered by the peer communication unit 220, and to store the peer communication identity associated with location information when the peer device 40a, 40b becomes out of range. In this case, the information gathering rule is may have a form such as shown in Table 3.

TABLE 3

RULE:
<Store Bluetooth devices WHEN out of coverage>
<Periodicity= 1 day>

In this example according to Table 3, whenever a Bluetooth device in the local environment goes out of range, the information gathering unit 260 immediately stores the Bluetooth ID, Time, and GPS location of that peer device 40a, 40b.

Later, when the user wishes to find the misplaced peer device, in this case their Bluetooth headset 40a, the information gathering unit 260 retrieves the gathered peer information which indicates the last known position of the peer device. Accordingly, the user is better able to track and locate lost devices.

The mobile device 20 may upload all of the gathered peer information to the remote server, such as the information server 30, to be stored in a gathered information database 35. The gathered information may be uploaded periodically as set in the information gathering rules, such as once every day, as indicated by Table 3 above.

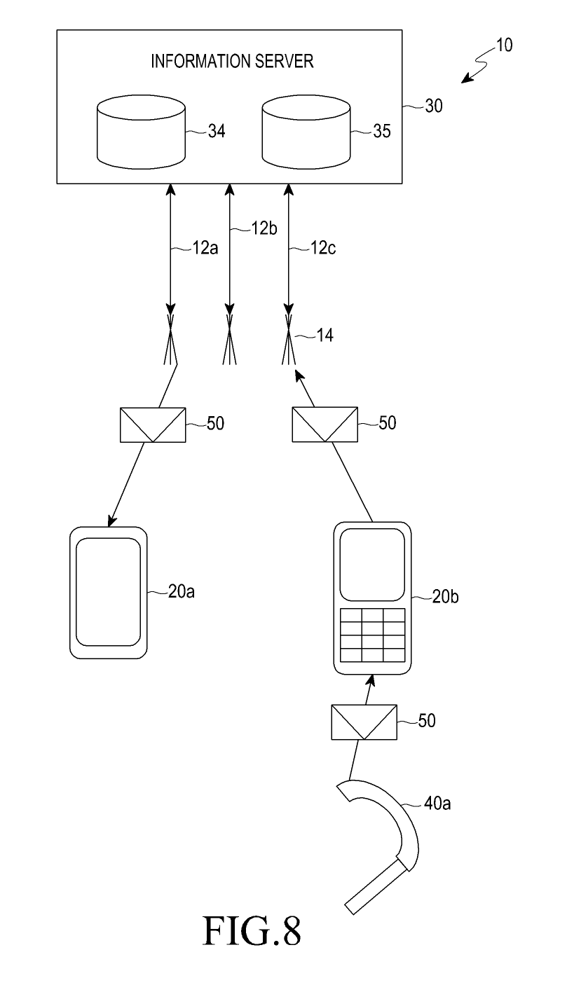

FIG. 8 illustrates another example of a wireless network system including the same mobile devices 20a, 20b, 20c, etc., as discussed above.

Referring to FIG. 8, each of the plurality of mobile devices 20a, 20b, 20c have an information gathering unit 260, and therefore gather the peer information 50 using the peer communication unit 220 for each of the peer devices 40a, 40b that are encountered. As a result, by uploading this gathered peer information 50 to the remote server, such as the information server 30, a collaborative database 35 of the gathered peer information is assembled.

As an example, suppose the user of the first mobile device 20a misplaces their Bluetooth headset 40a. Meanwhile, the headset 40a is encountered by the second mobile device 20b, which gathers and uploads the relevant peer information 50 to the database 35. Later, the first mobile device 20a sends an information request for the peer information relevant to this peer identity (e.g., by providing the Bluetooth ID of the headset 40a), and, in response, the remote server 30 provides the gathered peer information 50 as gathered by the second mobile device 20b providing the last-known time and location information for the headset 40a.

Table 4 is an example of a request made by the information server 30 to the mobile device 20 similar to Table 2 above, but additionally requesting information relating to two Bluetooth objects. Table 5 is an example of a corresponding response from the mobile device 20, which provides GPS location information relating to these two devices.

TABLE 4
Sample Info response RDF Data List from server:

0:

<?xml version=“1.0” encoding=“utf-8”?>
<sparql xmlns=“http://www.w3.org/2005/sparql-results#”>

<head>

<variable name=“rule startup”/>
<variable name=“rule info sharing”/>

</head>
<results>

<result>

<binding name=“rule start up”><literal>config

rule</literal></binding>

<binding name=“GPS

sharing”><literal>ON</literal></binding>

<binding name=“Client ID”><literal>Client MIHF_ID

1</literal></binding>

<binding name=“Accept

Clients”><literal>ON</literal></binding>

<binding name=“Time interval”><literal>10

min</literal></binding>

<binding name=“Battery Level”><literal>70

%</literal></binding>

</result>
<result>

<binding name=“rule info sharing”><literal>Sharing

</literal></binding>

<binding name=“Bluetooth

objID”><literal>my_keys</literal></binding>

<binding name=“Bluetooth

objID”><literal>my_camera</literal></binding>

</result>

</results>

</sparql>

TABLE 5

Sample Info response RDF Data List from client:

0:

<?xml version=“1.0” encoding=“utf-8”?>
<sparql xmlns=“http://www.w3.org/2005/sparql-results#”>

<head>

<variable name=“rule info sharing”/>

</head>
<results>

<result>

<binding name=“rule info sharing”><literal>Sharing

</literal></binding>

<binding

name=“my_keys”><literal>GPS:108,100,100</literal></binding>

<binding name=“ my_camera”><literal>

GPS:190,110,110</literal></binding>

</result>

</results>

</sparql>

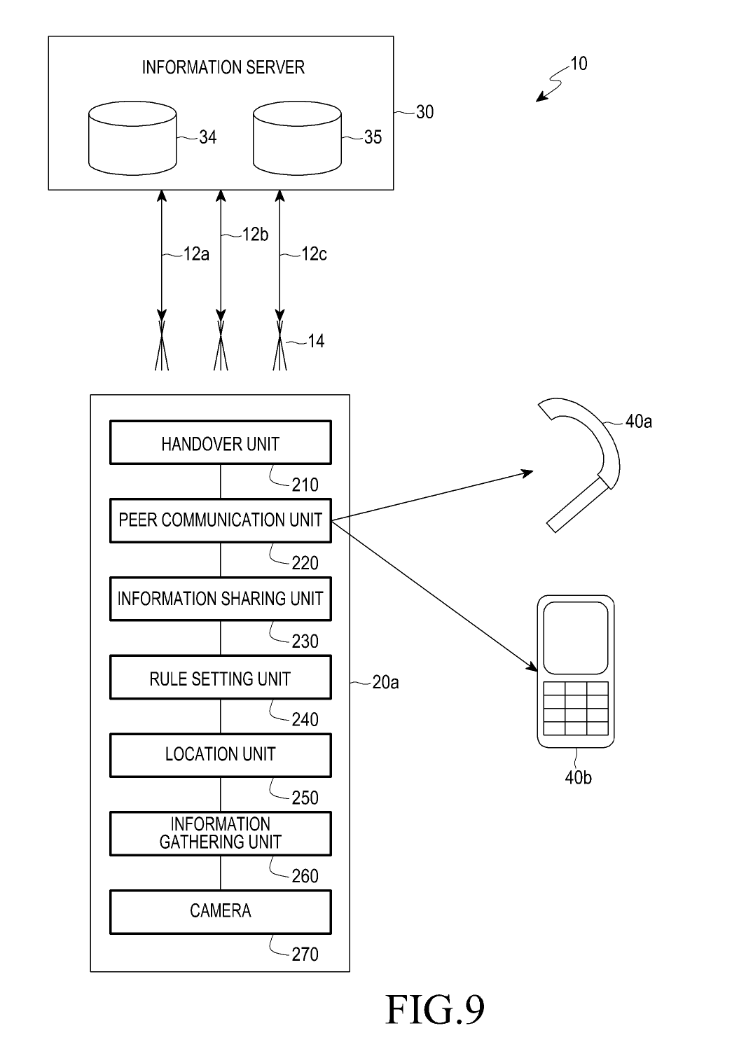

FIG. 9 illustrates another example of a wireless network system including the same mobile devices 20a, etc., as discussed above, according to an embodiment of the present invention.

Referring to FIG. 9, the first mobile device 20a further includes a camera 270. The information gathering unit 260 activates the camera 270 in order to gather an image of the location of the peer device 40a. The image is stored as part of the gathered peer information 50, to assist with locating the lost device.

The camera 270 may be left on whenever the mobile device 20a has sufficient battery. In this case, whenever the mobile device 20a comes into contact with an object that the user wishes to track, such as their car keys, the object is tagged by the mobile device and the image is gathered into the database of gathered information with the location, time, etc. Thus, when a user wishes to know the location of the object, the gathered information provides an indication of the last time and place that the object was in contact with the mobile device 20a.

At least some elements of embodiments of the present invention discussed herein may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks.

At least some elements of embodiments of the present invention may be may be configured to reside on an addressable storage medium and be configured to execute on one or more processors. The elements may be implemented in the form of a tangible computer-readable storage medium having recorded thereon instructions that are, in use, executed by a computer or other suitable device. These elements may include, for example, components such as software components, object-oriented software components, class components and task components, processes, functions, attributes, procedures, subroutines, segments of program code, drivers, firmware, microcode, databases, data structures, tables, arrays, and variables. The tangible medium may take any suitable form, but examples include solid-state memory devices (e.g., Read Only Memory (ROM), Random Access Memory (RAM), Erasable Programmable ROM (EPROM), Electrically Erasable Programmable ROM (EEPROM), etc.), optical discs (e.g. Compact Discs, Digital Versatile Discs (DVDs), and etc.), magnetic discs, magnetic tapes and magneto-optic storage devices.

Embodiments of the present invention have been described with reference to the example components, modules and units discussed herein. Where appropriate, these functional elements may be combined into fewer elements or separated into additional elements. In some cases the elements are distributed over a plurality of separate computing devices that are coupled by a suitable communications network, including any suitable wired networks or wireless networks.

Although a few embodiments of the present invention have been shown and described, it will be appreciated by those skilled in the art that various changes and modifications might be made without departing from the scope of the invention, as defined in the appended claims.

What is claimed is:

1. A wireless network system including a plurality of wireless networks, the wireless network system comprising:
a plurality of mobile devices coupled to the plurality of wireless networks, the plurality of mobile devices including at least a first mobile device and a second mobile device; and
an information server coupled to each of the plurality of wireless networks, wherein the information server provides handover messages to the plurality of mobile devices to assist the mobile devices in performing a handover from one of the wireless networks to another one of the wireless networks,
wherein the first mobile device negotiates information sharing rules with the information server, and
wherein the first mobile device provides, to the second mobile device, shared information according to the information sharing rules.

2. The wireless network system of claim 1, wherein the first mobile device transmits the shared information directly to the second mobile device via peer communication.

3. The wireless network system of claim 1, wherein the second mobile device initiates the information sharing by sending an information sharing request to the information server.

4. The wireless network system of claim 3, wherein the second mobile device identifies the first mobile device as being proximal to the second mobile device by using the peer communication, obtains a peer communication identifier corresponding to the first mobile device, and provides the peer communication identifier to the information server in the information sharing request.

5. The wireless network system of claim 1, wherein the first mobile device negotiates the information sharing rules with the information server during a capability message exchange between the first mobile device and the information server.

6. The wireless network system of claim 1, wherein the information sharing rules are based on a device status of a hardware component of the first mobile device.

7. The wireless network system of claim 1, wherein the first mobile device includes a location unit for obtaining location information based on a geographical location of the first mobile device,
wherein the first mobile device shares the location information with the second mobile device as the shared information, and
wherein the second mobile device accesses a location based service over the wireless network using the location information shared by the first mobile device.

8. The wireless network system of claim 1, wherein the information server aggregates a plurality of the mobile devices into a sharing group based on location information, speed information and/or direction information provided by the mobile devices, which indicates that the plurality of mobile devices are within a same location suitable for sharing information.

9. The wireless network system of claim 1, wherein:
the first mobile device gathers object information about at least one object encountered by the first mobile device according to the information sharing rules;
the information server receives the gathered object information from the first mobile device and selectively provides the gathered object information to at least one of the mobile devices other than the first mobile device, in response to a request for the object information.

10. The wireless network system of claim 9, wherein the first mobile device gathers the object information as peer information about at least one peer communication device encountered by the peer communication or as image information captured by a camera of the first mobile device.

11. The wireless network system of claim 1, wherein the information server includes:
an information sharing rules database for storing information sharing rules relating to at least a first mobile device of the plurality of mobile devices; and
a handover information services unit for receiving a request for information sharing from a second mobile device of the plurality of mobile devices, determining whether the first mobile device is capable of sharing information based on the stored information sharing rules, and issuing, to the first mobile device, a command that requests information sharing according to the information sharing rules for the first mobile device, in order to share information with the second mobile device in response to the command.

12. The wireless network system of claim 1, wherein at least one of the plurality of mobile devices includes:
a handover unit for performing handovers within the wireless network system according to handover messages provided by an information server;
a peer communication unit for communicating directly with at least one other mobile device in the vicinity of the mobile device;
a rule setting unit for negotiating the information sharing rules with the information server; and
an information sharing unit for sharing information with the other mobile devices according to the information sharing rules negotiated by the rule setting unit.

13. The wireless network system of claim 12, wherein the at least one mobile device further includes:
an information sharing unit for receiving shared information from the other mobile devices according to the information sharing rules negotiated by the rule setting unit.

14. A method of providing information in a wireless network system having a plurality of wireless networks, the method comprising:
sending, by an information server, handover messages to a first mobile device in the wireless network system;
performing, by the first mobile device, a handover from one of the plurality of wireless networks to another one of the wireless networks using the handover messages;
negotiating, by the first mobile device, information sharing rules with the information server; and
providing, by the first mobile device, shared information to a second mobile device according to the information sharing rules.

15. A non-transitory computer readable medium having recorded thereon instructions which, when executed, cause a computer to perform a method comprising:
sending, from an information server, handover messages to a first mobile device in a wireless network system having a plurality of wireless networks;
performing a handover of the first mobile device from one of the wireless networks to another of the wireless networks using the handover messages;
negotiating information sharing rules between the information server and the first mobile device; and
sending shared information from the first mobile device to a second mobile device according to the information sharing rules.
